(19) United States
(12) Patent Application Publication
(10) Pub. No.: US 2005/0243030 A1
(43) Pub. Date: Nov. 3, 2005

(54) Electron emission display and driving method thereof

(76) Inventors: Sang-Hyuck Ahn, Suwon-si (KR); Sang-Jo Lee, Suwon-si (KR); Su-Bong Hong, Suwon-si (KR)

Correspondence Address: MCGUIREWOODS, LLP, 1750 TYSONS BLVD, SUITE 1800, MCLEAN, VA, 22102, US

(21) Appl. No.: 11/111,842

(22) Filed: Apr. 22, 2005

(30) Foreign Application Priority Data
Apr. 29, 2004 (KR) 10-2004-0029997

(51) Int. Cl. G09G 3/22

(52) U.S. Cl. 345/74.1

(57) ABSTRACT

According to the present invention, the electron emission display includes a display panel, a data electrode driver, a scan electrode driver, and a voltage compensator. The display panel includes a plurality of scan electrodes and data electrodes arranged in a matrix format, and displays an image in response to a voltage applied to the scan electrode and the data electrode. The data electrode driver applies a data signal with first and second voltages to the data electrode. The scan electrode driver applies a third voltage level to a selected scan electrode, and applies a fourth voltage level to a non-selected scan electrode among the plurality of scan electrode. The voltage compensator controls a fourth voltage level by using grayscale information of an image signal.

### CLAIM OF PRIORITY

This application claims the benefit of Korean Patent Application No. 10-2004-0029997, filed Apr. 29, 2004, which is incorporated herein by reference in its entirety.

### BACKGROUND OF THE INVENTION

1. Field of the Invention

The present invention relates, for example, to a display device. More specifically, the present invention relates, for example, to an electron emission display and driving method thereof.

2. Discussion of the Related Art

In general, a flat panel display (FPD) is a display device in which sealing material are provided between two substrates to manufacture an airtight device, and appropriate elements are arranged in the airtight device to display desired images. FPD technology is increasingly important because of the development of multimedia technologies. Accordingly, various flat displays such as liquid crystal displays (LCD), organic light emitting displays, and field emission displays (FED) have been put to practical use.

In particular, since an electron emission display uses phosphorous emission caused by electron beams (similar to the mechanism of a cathode ray tube (CRT)), it has a high probability of realizing a flat-type display that maintains the excellent characteristics of the CRT, provides no image distortion, and allows low power consumption. In particular, it satisfies a wide viewing angle, high-rate response, high resolution, fineness, and slimness criteria. Accordingly, it has become the center of public attention as the next-generation display.

The electron emission display uses a cold cathode rather than a hot cathode. Electron emission displays using a cold cathode include field emitter array (FEA), a surface conduction emitting (SCE), and a metal-insulator-metal (MIM) display.

FIG. 1 and FIG. 2 show diagrams of an electron emission display. FIG. 1 is a partial perspective view of a display panel 10 of the electron emission display, and FIG. 2 is a cross sectional view of the display panel 10.

As shown in FIG. 1 and FIG. 2, the electron emission display includes a rear substrate 1 and a front substrate 2. A cathode electrode 11 and a gate electrode 12 are formed with an insulation layer provided therebetween on the rear substrate 1. An emitter 13 for emitting electrons depending on voltage applied to the cathode electrode 11 and the gate electrode 12 is formed on the cathode electrode 11.

The front substrate 2 is formed to face the rear substrate 1. An anode electrode 14 for pulling electrons emitted from the emitter 13 is formed on the front substrate 2. A phosphor surface 15 with red, green, and blue phosphors that emit light when the pulled electrons collide is formed on the anode electrode 14.

The above-configured electron emission display concentrates high electric field on the emitter to emit electrons according to the quantum-mechanical tunnel effect. Electrons emitted from the emitter are accelerated by a voltage applied between the cathode electrode and the anode electrode, and collide with the phosphor surfaces formed on both electrodes to emit light and display images.

Brightness of the images displayed by the emitted electrons colliding with the phosphor surfaces 15 is controlled according to values of input digital image signals. The values of the digital image signals have 8 bit RGB data. That is, the values of the digital image signals cover 0(00000000₍₂₎) to 255(11111111₍₂₎). 256 grayscales are represented by the 256 values, and brightness is also represented by the data values.

FIG. 3 shows a diagram for representing a conventional electron emission display, and FIG. 4 shows a driving waveform of the conventional electron emission display.

As shown in FIG. 3, the conventional electron emission display includes a display panel 10, a data electrode driver 20, and a scan electrode driver 30.

The data electrode driver 20 applies a data pulse Vd to data electrodes D1 to Dm, and the scan electrode driver 30 sequentially applies a scan pulse Vs to scan electrodes S1 to Sn. In a method for driving the conventional electron emission display, a low voltage level of the data pulse Vd is established to correspond to a high voltage level of the scan pulse Vs, which is generally established to be 0V as shown in FIG. 4.

A positive data pulse Vd is applied to the data electrode D1 to Dm, and a negative scan pulse Vs is applied to the scan electrode S1 to Sn. Thus, an appropriate image is displayed on the panel 10.

However, when the electron emission display shown in FIG. 3 operates practically, there is a pixel in which the data electrode and the scan electrode are short-circuited. When this occurs, leakage current flows through the short-circuited data electrode. Therefore the data driver 20 uses a high current integrated circuit (IC) in order to apply an appropriate voltage to the data electrode D1 to Dm of the selected pixel. This increases cost of the data electrode driver 20 as well as power consumption.

In addition, in the conventional electron emission display, brightness of the panel 10 increases as a data pulse Vd voltage level increases. However, the voltage difference increases between a non-selected scan electrode and a data electrode. This may cause a non-selected pixel to discharge and emit light, which is problematic. Accordingly, there was a limit to improve brightness of the display panel 10 in the conventional driving method.

### SUMMARY OF THE INVENTION

The present invention provides, for example, an electron emission display that can consume less power. The present invention also provides an electron emission display that can increase brightness of the display panel. The present invention also provides driving methods for the above electron emission displays.

The present invention discloses, for example, an electron emission display that can include a display panel, a data electrode driver, a scan electrode driver, and a voltage compensator. The display panel can display an image in response to voltage applied between scan electrodes and data electrodes that are provided in the display panel in a matrix format. The data electrode driver can apply a data signal with first and second voltage levels to the data electrode. The scan electrode driver applies third and fourth voltage levels to selected and non-selected scan electrodes respectively. The voltage compensator can control a fourth voltage level based on grayscale information of an image signal.

### BRIEF DESCRIPTION OF THE DRAWINGS

FIG. 1 is a partial perspective view of a display panel 10 of the electron emission display.

FIG. 2 is a cross sectional view of the display panel 10.

FIG. 3 shows a diagram for representing a conventional electron emission display.

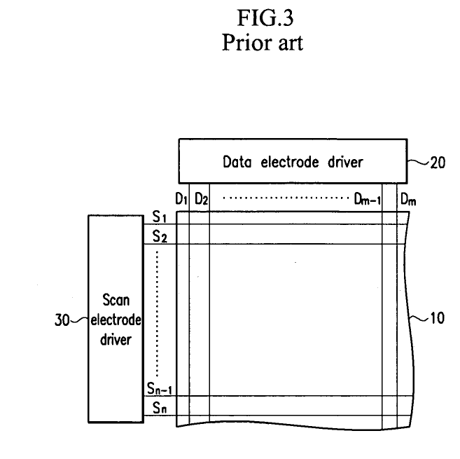

FIG. 4 shows a driving waveform of the conventional electron emission display.

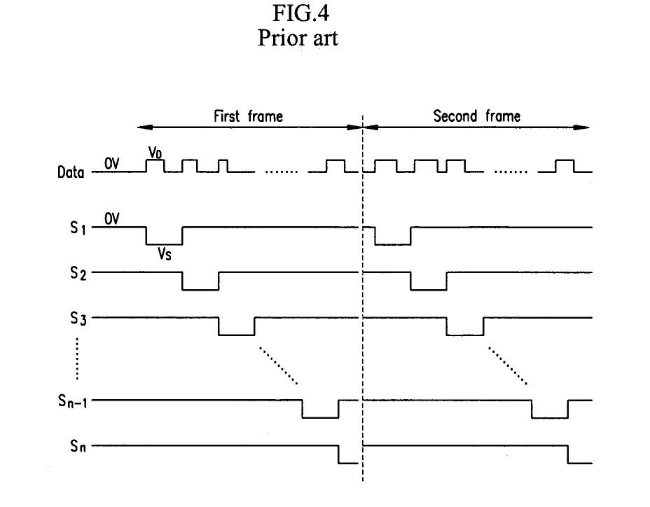

FIG. 5 shows an electron emission display of an example embodiment of the present invention.

FIG. 6 shows a diagram for representing driving voltages applied to the data electrode and the scan electrode.

FIG. 7 shows driving waveforms of the electron emission display of an example embodiment of the present invention.

FIG. 8 is a diagram for representing the magnified scan pulse in a first frame and a second frame.

### DETAILED DESCRIPTION

The present invention will now be described in detail with reference to the accompanying drawings in which example embodiments of the invention are shown. The invention may, however, be embodied in different forms and should not be construed as limited to the embodiments shown and described. The dimensions in the drawings are exaggerated for clarity. The same reference numerals are used to denote the same elements throughout the specification.

The drawings and description are to be regarded as illustrative in nature and not restrictive. Phrases such as “one thing coupled to another” can refer to either “directly coupling a first one to a second one” or “coupling the first one to the second one with a third one provided therebetween.”

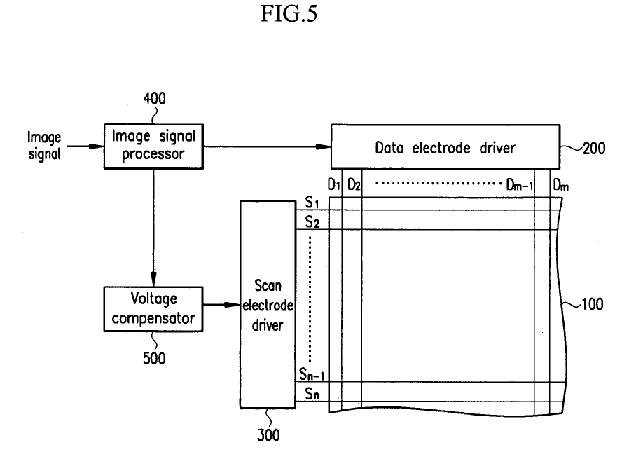

As shown in FIG. 5, the electron emission display of an example embodiment of the present invention can include a display panel 100, a data electrode driver 200, a scan electrode driver 300, an image signal processor 400, and a voltage compensator 500.

The data electrode driver 200 can apply a data signal to the data electrodes D1 to Dm, and the scan electrode driver 300 can apply a scan signal to the scan electrodes S1 to Sn.

The image signal processor 400 can gamma-correct the input image signal and transmit the gamma corrected image signal to the data electrode driver 200. It can also extract grayscale information from the image signal and transmit the extracted information to the voltage compensator 500. According to the example embodiment of the present invention, the image signal processor 400 transmits the frame-based grayscale information of the input image signal to the scan electrode driver 300.

The voltage compensator 500 can minimize leakage current flowing through a short-circuited data electrode by controlling the voltage level of a scan pulse applied to scan electrodes S1 to Sn. The leakage current flowing through the short-circuited data electrode may increase when the duration of the data pulse applied to the data electrode increases. The increased leakage current may affect the grayscales of an image displayed on the panel 100. Accordingly, the voltage compensator 500 may control the voltage level of the scan pulse based on the grayscale information of the image transmitted from the image signal processor 400.

The voltage compensator 500 may, in certain embodiments, control the voltage level of the scan pulse for each frame. This kind of control is described in an illustrative manner below.

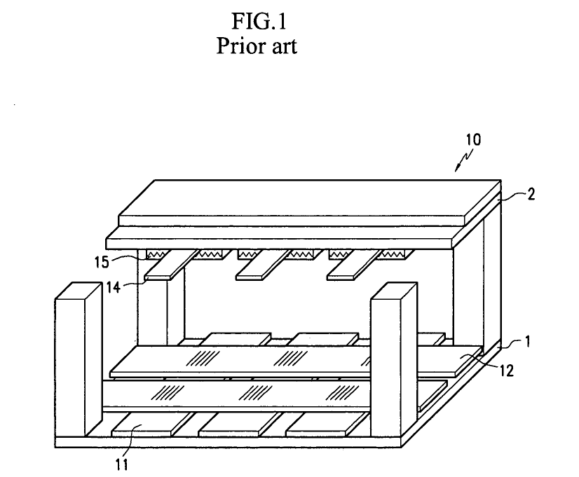

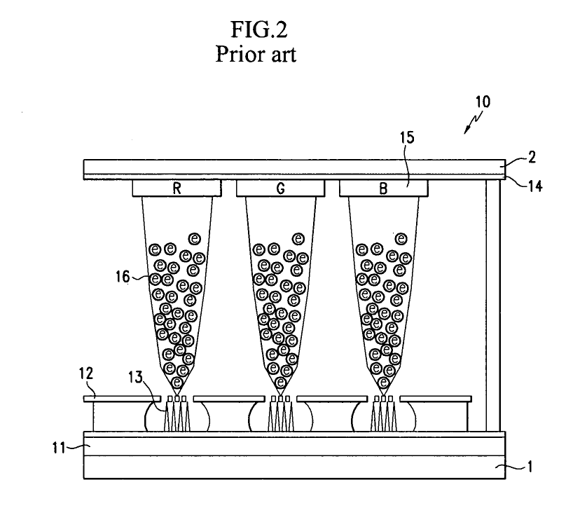

Although the display panel 100 of the electron emission display may be formed as shown in FIG. 1 and FIG. 2, various display panels may be used with various embodiments.

A cathode electrode 11 may be used as the scan electrode, and a gate electrode 20 may be used as the data electrode. Alternatively, the cathode electrode 11 may be used as the data electrode, and the gate electrode 12 may be used as the scan electrode.

Although the gate electrode 12 may be formed on the cathode electrode 11 with an insulation layer provided therebetween as in FIG. 1 and FIG. 2, the cathode electrode may alternatively be formed on the gate electrode of certain embodiments.

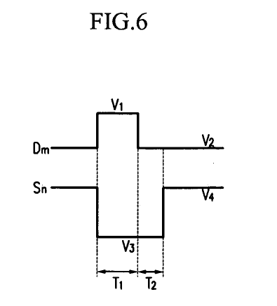

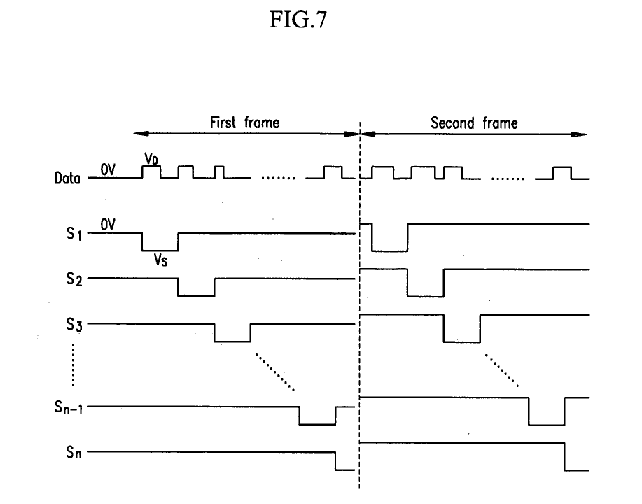

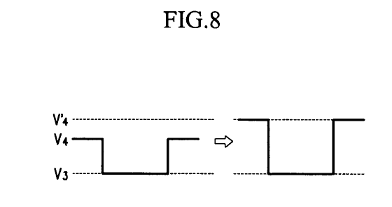

A driving method of an example embodiment of the present invention will be now described with reference to FIG. 6, FIG. 7, and FIG. 8.

In FIG. 6, voltages applied to an m^{th} data electrode Dm (among the data electrodes D1 to Dm) and an n^{th} scan electrode Sn (among the scan electrodes S1 to Sn) are illustrated.

In a period of T1, a high level data pulse V1 may be applied to the data electrode Dm, and a low level scan pulse V3 may be applied to the scan electrode Sn. Electrons may emit from an emitter by a voltage of (V1−V3) applied between the data electrode Dm and the scan electrode Sn. The emitted electron may then collide with a phosphor surface formed on the anode electrode. Thus, an image may be displayed.

In a period of T2, a low voltage level of V2 may be applied to the data electrode Dm, and a low level scan pulse V3 may be applied to the scan electrode Sn. Therefore the voltage applied between the data electrode Dm and the scan electrode Sn may be reduced to a voltage of (V2−V3), and no electrons may be emitted from the emitter.

The grayscales of an image may be displayed for the duration of T1 of the data pulse, and a desired image may be represented on the display panel 100 (as shown in FIG. 5).

Hereinafter, a ratio of the duration period of T1 in which the data pulse is applied to the data electrode Dm to a pixel selection period of (T1+T2) in which the scan pulse is applied to the scan electrode Sn is referred to as a grayscale expression ratio td.

A method for controlling the scan pulse applied to the scan electrode by the voltage compensator 500 will now be described.

When a short-circuit is generated between the data electrode and the scan electrode in the display panel 100, leakage current can flow through the data electrode. The leakage current may be mostly generated by a voltage difference between the data voltage and the scan electrode (hereinafter ‘non-selected scan electrode’) which the scan pulse (V3) is not applied to, and the high scan electrode voltage V4 is applied to.

When a voltage of V4 applied to the non-selected scan electrode is practically established to correspond to the low voltage level of V2 of the data pulse, leakage current Id flowing through the data electrode may be given.

When the voltage of V4 applied to the non-selected scan electrode is practically established to correspond to the low voltage level of V2 of the data pulse and the voltage applied to the data electrode is varied from the low level of V2 to the high level of V1, a large current may momentarily flow to the data electrode. This momentary current may affect data electrode driver 200.

Accordingly, as the grayscales of the image displayed on the panel 100 increase (e.g., white is represented on the panel), the load of the data electrode driver 200 may increase.

However, when the voltage of V4 applied to the non-selected scan electrode is practically established to correspond to the high voltage level of V1 of the data pulse, the leakage current Id flowing through the data electrode may be given as Equation 1.
Id=(Vd−V4)×(1−td)/Rd [Equation 1]
in which Vd may denote a voltage applied to the data electrode, td may denote a grayscale expression ratio, and Rd may denote the internal resistance of the data electrode.

As shown in Equation 1, when the data pulse is varied from the high level of V1 to the low level of V2, a large current momentarily flows to the data electrode. That is, when grayscales of a dark screen are represented on the screen, the load of the data electrode driver 200 is increased. At this time, the current of the data electrode flows in an opposite direction to the leakage current Id flowing through the data electrode.

Accordingly, the voltage of V4 applied to the non-selected scan electrode is required to be properly established between the high level of V1 and the low level of V2 of the data pulse.

When the voltage of V4 applied to the non-selected scan electrode is established between the voltage of V1 and the voltage of V2, a current (hereinafter, referred to as a positive leakage current) shown in Equation 2 may flow from the data electrode to the scan electrode in the period of T1 shown in FIG. 6, and a current (hereinafter, referred to as a negative leakage current) shown in Equation 3 flows from the scan electrode to the data electrode in the period of T2 in FIG. 6.
Id+=(Vd−V4)×td/Rd=(V1−V4)×td/Rd [Equation 2]
Id−=(Vd−V4)×(1−td)/Rd=(V4−V2)×(1−td)/Rd [Equation 3]

Accordingly, the positive leakage current Id+ may flow to the data electrode when the data pulse is maintained at the high level, and the negative leakage current Id− may flow to the data electrode when the data pulse is maintained at low level. Thus, the amount of leakage current flowing through the data electrode may be relatively reduced, the time when the leakage current flows may be diversified, and therefore the load of the data electrode driver 200 may be efficiently reduced.

When the positive leakage current Id+ and the negative leakage current Id− practically correspond with each other, the current flowing through the data electrode may be 0 on average, and the load of the data electrode driver 200 may be greatly reduced.

A voltage of V4′ applied to the non-selected scan electrode may be given as the Equation 4 when the positive leakage current Id+ and the negative leakage current Id− correspond to each other.
V4′=(V1−V2)×td+V2 [Equation 4]

When a pulse width modulation (PWM) driving method is employed, the voltage applied to the non-selected scan electrode may be increased in proportion to the grayscale expression ratio td of the image signal because the high level of V1 and the low level of V2 of the data pulse may be maintained at a predetermined level.

The leakage current flowing through the data electrode may be minimized by controlling the voltage applied to the non-selected scan electrode based on calculated grayscales expression ratio td when the short circuit is generated between the data electrode and the scan electrode.

The grayscales in the first frame may be greater than the same in the second frame in FIG. 7 and FIG. 8. The voltage applied to the non-selected scan electrode in the second frame may be established to be greater than the same in the first frame.

The voltage of V3 of the scan pulse applied to the selected scan electrode in the first frame may be established to correspond to the same in the second frame. Accordingly, an image may be displayed without being affected by the voltage difference because the voltage difference between the data pulse V1 and the scan pulse V3 for emitting electrons from the emitter may be maintained at a predetermined level.

When the voltage of V4 of the non-selected scan electrode is established to be greater than the low voltage level of V2 of the data pulse, no emission may be generated by the voltage difference (V1−V4) between the non-selected scan electrode and the data electrode when the high voltage level of V1 of the data pulse is slightly increased. Accordingly, the high level of the data pulse may be further increased compared to the conventional driving method, and the brightness of the electron emission display is increased.

Thus, the voltage compensator 500 may control the voltage of V4 of the non-selected scan electrode by using the grayscale information of the image signal. The voltage compensator 500 may also control the voltage of V1 of the data pulse applied to the data electrodes D1 to Dm to thus increase brightness of the electron emission display.

The present invention may improve power consumption of an electron emission display device. In addition, it may also improve brightness of a display panel.

Although the invention has been particularly described with reference to certain embodiments thereof, changes may be made to these embodiments without departing from the scope of the invention.

For example, although the grayscale information of the image signal may be transmitted from the image signal processor 400 to the voltage compensator 500 as described, the voltage compensator 500 may extract the grayscale information from the data electrode driver 200 of example embodiments. In addition, although the voltage compensator 500 may be formed separate from the scan electrode driver 300, it may alternatively be formed in the scan electrode driver 300.

1. An electron emission display, comprising:
a display panel for displaying an image in response to voltages applied to scan electrodes and data electrodes that are provided in the display panel in a matrix format;
a data electrode driver for applying a data signal with a first voltage level and a second voltage level to the data electrode;
a scan electrode driver for respectively applying a third voltage level and a fourth voltage level to selected and non-selected scan electrodes of the plurality of scan electrodes; and
a voltage compensator for controlling the fourth voltage level based on grayscale information of an image signal.

2. The electron emission display of claim 1, further comprising:
an image signal processor;
wherein the image signal processor can gamma-correct the image signal and transmit the gamma corrected image signal to the data electrode driver; and
wherein the image signal processor can extract the grayscale information from the image signal and outputting the extracted grayscale information to the voltage compensator.

3. The electron emission display of claim 2, wherein the image signal processor outputs frame-based grayscale information of the image signal to the voltage compensator.

4. The electron emission display of claim 1, wherein the voltage compensator controls the fourth voltage level applied to the non-selected scan electrode frame by frame.

5. The electron emission display of claim 1, wherein the data electrode driver controls a period in which the first voltage level is applied to the data electrode in response to the image signal.

6. The electron emission display of claim 1, wherein the voltage compensator controls the fourth voltage level to be between the first voltage level and the second voltage level.

7. The electron emission display of claim 6, wherein the voltage compensator calculates the fourth voltage level using V4=(V1−V2)×td+V2,
where V1 denotes the first voltage level, V2 denotes the second voltage level V4 denotes the fourth voltage level, and td denotes a ratio of a first voltage level period to a scan electrode selection period, the first voltage level period is a period for which the first voltage level is applied to the data electrode.

8. The electron emission display of claim 1, wherein the third voltage level is maintained at a constant level.

9. The electron emission display of claim 1, the voltage compensator further controls, on the basis of the grayscale information of the image signal, the first voltage level applied to the data electrode.

10. An electron emission display, comprising:
a display panel for displaying an image in response to a voltage applied to scan electrodes and data electrodes that are provided in the display panel in a matrix format;
a data electrode driver for applying a data signal corresponding to an image signal to the data electrode; and
a scan electrode driver for applying a scan signal to the scan electrode,
wherein the scan electrode driver controls a voltage level of the scan signal in response to the image signal.

11. The electron emission display of claim 10, wherein the scan electrode driver controls a voltage of a non-selected scan electrode among the plurality of scan electrodes.

12. The electron emission display of claim 10, wherein the scan electrode driver controls the voltage level of the scan signal based on frame-based grayscale information of the image signal.

13. The electron emission display of claim 12, wherein, if the data voltage has a first voltage level and a second voltage level, a voltage applied to the non-selected scan electrode is controlled to be in a voltage range between the first voltage level and the second voltage level.

14. A method for driving a display panel for displaying an image in response to voltages applied to scan electrodes and data electrodes that are provided in the display panel in a matrix format, comprising:
applying a data signal corresponding to an image signal to a data electrode; and
sequentially applying a first voltage level scan pulse to one of a plurality of scan electrodes, and maintaining the scan electrode at a second voltage level;
wherein the second voltage level in one frame is established to be different from the second voltage level in another frame.

15. The method of claim 14, wherein the second voltage level is established based on grayscale information of the image signal.
